(19) United States
(12) Patent Application Publication
(10) Pub. No.: US 2014/0246156 A1
(43) Pub. Date: Sep. 4, 2014

(54) CORD MANAGEMENT FOR A WINDOW COVERING

(71) Applicants: Aaron B. Dorny, Gilbert, AZ (US); Kendall W. Prince, Mesa, AZ (US); Don A. Patterson, Gilbert, AZ (US)

(72) Inventors: Aaron B. Dorny, Gilbert, AZ (US); Kendall W. Prince, Mesa, AZ (US); Don A. Patterson, Gilbert, AZ (US)

(21) Appl. No.: 14/012,993

(22) Filed: Aug. 28, 2013

Related U.S. Application Data
(60) Provisional application No. 61/771,794, filed on Mar. 1, 2013.
(60) Provisional application No. 61/837,609, filed on Jun. 20, 2013.

(51) Int. Cl. E06B 9/38

(52) U.S. Cl. CPC E06B 9/38
USPC 160/172 R

(57) ABSTRACT

The present invention relates to cord management systems for window coverings. More particularly, the present invention relates to various structures and features to lift and/or tilt Venetian-type horizontal blind slats.

### RELATED APPLICATIONS

This application claims priority to U.S. Provisional Patent Application Ser. No. 61/771,794, filed Mar. 1, 2013 and titled PROVIDING CORD MANAGEMENT WITHIN A SYSTEM OF PIVOTING BLIND SLATS, and U.S. Provisional Patent Application Ser. No. 61/837,609, filed Jun. 20, 2013 and titled LIFT CORD FOR LOW PROFILE HEAD RAIL, both of which are incorporated herein in their entireties.

### BACKGROUND OF THE INVENTION

1. Field of the Invention

The present invention relates generally to blinds or coverings for windows or for other similar openings. More particularly, the present invention relates to a window covering having various structures and features to lift and tilt traditional Venetian-type horizontal blind slats.

2. Background Information

Blinds are often used to cover windows and other similar openings to provide privacy and/or to control the level of light that enters a room. A popular type of blind, sometimes called a “Venetian” blind, comprises a series of spaced-apart blind slats assembled parallel to each other. As a type of window covering, Venetian blinds offer versatility in controlling light or view and are easy to use.

A common, commercially available Venetian blind generally includes a head rail, a bottom rail, a plurality of blind slats, and a means for tilting and/or lifting the blind slats. The slats are generally suspended from the head rail via a system of cords that form a ladder. The ladder comprises forward and rearward rails that are interconnected with a plurality of rungs and cords. Each rung of the ladder is configured to hold a blind slat at a desired distance from an adjacent blind slat. The ladder is further connected to the head rail and the bottom rail via a complex system of cords.

The components of the tilting and lifting means for a traditional Venetian blind can be quite complex, expensive, bulky and heavy. Tilting and lifting the blind slats is generally accomplished by moving various cords that are coupled to the blind slats and the various components within the head rail. Traditional window covering components require the use of multiple cords that must be carefully managed to maintain proper working order. A portion of these cords are located externally to the head rail so as to be accessible by a user. The lift cords commonly become tangled thereby providing an undesirable appearance. The cords may further present a hanging hazard as a user, child or animal as they may become entangled within the cords and suffer serious injury, including death.

Accordingly, there is a need in the art for improved systems and methods for lifting and tilting blind slats that minimizes or eliminates present hazards and undesirable aesthetics. Specifically, there is a need for a window covering system that addresses and eliminates the requirements of complex and dangerous cord arrangements. Such a window covering system is disclosed herein.

### SUMMARY OF THE INVENTION

The present invention relates generally to blinds or coverings for windows or for other similar openings. More particularly, the present invention relates to various systems, methods, and devices for cord management within a head rail of a window covering. In some implementations, the embodiments of the present invention are intended for use with Venetian-type horizontal blind slats. Some implementations of the present invention are further intended for use with a low profile head rail.

Some implementations of the present invention include a window covering having a head rail which includes a plate having a length sufficient to cover, or at least partially cover a window opening. The head rail of the present invention may include a standard profile or a low profile as compared to traditional, Venetian-type horizontal blinds. A low profile head rail may be accomplished by providing low profile tilting and lifting components, as compared to the lifting and tilting components of traditional Venetian-type horizontal blinds. These low profile lifting and tilting components may also be used with traditional or standard head rails to receive the benefits provided thereby.

Some implementations of the present invention provide a cord management system for a window covering which includes a head rail having a plate on which is mounted a cord guide. In accordance with the present teaching, a cord guide may include a pulley, a grommet, a post, a loop, a hoop, a stringer, a reel, a drum, an eyelet, or any device having a similarly functional structure. In some instances the cord guide is rotatably coupled to an axle that is supported or directly attached to the head rail. The system further include a first cord having a working end coupled to a bottom rail of a set of slats, and further includes a terminal end positioned external to the head rail and accessible to a user. A first cord may be used to lift the blind slats. The first cord may alternatively be used to tilt the blind slats. In some instances a first cord is provided to lift the blind slats, and a second cord is provided to tilt the blind slats. Further still, in some instances a single cord is provided that is capable of at performing at least one function of lifting or tilting the blind slats.

The first cord includes a middle section that is supported by a cord guide. In some instances, the first cord is horizontally oriented along a length of the head rail, wherein a distance between the terminal end of the first cord and the head rail decreases as a distance between the working end of the first cord and the head rail increases.

The cord management system may further include a cord drive component rotatably coupled to the head rail in a generally horizontal orientation. In some instances the cord management system includes a tilt cord having a first terminal end, a second terminal end, a first working end, and a second working end. The first and second working ends are coupled to distal and proximal edges of a blind slat, and the first and second terminal ends are coupled to the cord drive component. As the cord drive component is activated, the first and second working ends move in opposite directions to rotate the blind slat about a radial axis, thereby causing the blind slat rotate and/or tilt.

In some instances, the tilt cord comprises a ladder cord having independent terminal ends that are secured to the cord drive component. The ladder further comprises a plurality of rungs that oriented in a horizontal position to support the plurality of blind slats suspended beneath the head rail. Thus, the blind slat is not directly coupled to the tilt cord, but rather is supported on the individual rungs of the ladder cord. As the cord drive component is rotated, the ladder cord is shifted or rotated thereby tilting the horizontal position of the rungs and causing the blind slats to pivot and/or tilt.

A cord management system in accordance with the present invention may further include a plurality of cord guides coupled to the head rail via a plurality of axles. In some instances, a plurality of cord guides is utilized to route a cord back and forth across the length of the head rail. For example, in some instances a plurality of cord guides are mounted to the head rail via a plurality of axles to route a cord back and forth across the length of the head rail in a zigzag pattern.

The present invention may further include a tilt or lift cord having a single terminal end and a plurality of working ends that are attached to at least one of a blind slat or a bottom rail of the window covering. In some instances, a tilt or lift cord is indirectly attached to at least one of the a blind slat and a bottom rail of the window covering. As thus configured, a user may manipulate the single terminal end to actuate the plurality of working ends in unison.

Some implementations of the present invention further comprise a cord management housing that is capable of being fitted onto any head rail. The cord management housing comprises an axle on which is rotatably coupled one or more cord guides. The housing further comprises one or more protrusions that are fitted into openings within the head rail and provide a grommet-like barrier between a cord and the opening within the head rail. The one or more cord guides may comprise one or more grooves to support and maintain a position of a cord on the cord guide. The housing may further include one or more cord retention devices that are designed to prevent unintentional movement or displacement of the cords from the grooves of the cord guides. The cord retention devices may further be configured to provide and/or maintain a desired tension for the cord.

Some implementations of the present invention further include various cord designs. More specifically, the present invention provides various cords having a single terminal end and a plurality of working ends. The present invention also provides various methods by which the plurality of working ends are coupled to the single terminal end. Thus, a window covering is provided having a single, visible cord that is accessible by a user to lift, tilt, or lift and tilt a set of blind slats.

### BRIEF DESCRIPTION OF THE DRAWINGS

The foregoing and other objects and features of the present invention will become more fully apparent from the accompanying drawings when considered in conjunction with the following description. Although the drawings depict only typical embodiments of the invention and are thus not to be deemed as limiting the scope of the invention, the accompanying drawings help explain the invention in added detail.

FIG. 1 is a perspective view of a window covering in accordance with a representative embodiment of the present invention;

FIG. 2 is top view of a head rail having a lift cord management system in accordance with a representative embodiment of the present invention;

FIG. 3 is a top plan view of the head rail shown in FIG. 2;

FIG. 4 is a plan side view of a head rail having a lift cord system in accordance with a representative embodiment of the present invention;

FIG. 5, shown in parts A and B, illustrates a cross-section end view of a head rail having a lift cord system in accordance with a representative embodiment of the present invention;

FIG. 6 illustrates a perspective view of a head rail having combined lift and tilt cord management systems in accordance with a representative embodiment of the present invention;

FIG. 7 illustrates a top plan view of a head rail having combined lift and tilt cord management systems in accordance with a representative embodiment of the present invention;

FIG. 8 illustrates a side plan view of a head rail having combined lift and tilt cord management systems in accordance with a representative embodiment of the present invention;

FIG. 9 illustrates a perspective view of a head rail having combined lift and tilt cord management systems in accordance with a representative embodiment of the present invention;

FIG. 10 illustrates a perspective view of a head rail having combined lift and tilt cord management systems in accordance with a representative embodiment of the present invention.

FIG. 11A illustrates a top plan view of a cord guide housing in accordance with a representative embodiment of the present invention;

FIG. 11B illustrates a top plan view of a cord guide housing having a plurality of independent axles in accordance with a representative embodiment of the present invention;

FIG. 11C illustrates a top plan view of a cord guide housing having a single elongated opening in accordance with a representative embodiment of the present invention;

FIG. 11D illustrates a front, cross-section view of a cord guide housing in accordance with a representative embodiment of the present invention;

FIG. 11E illustrates a front, cross-section view of the cord guide housing of FIG. 11D further comprising a single elongated opening in accordance with a representative embodiment of the present invention;

FIG. 12 is a representative cord management system having the ability to tilt blind slats by using connectors, strings and a friction device;

FIG. 13 is a representative cord management system using longer tilt cords to connect directly to a consolidating connection that leads to a single cord for operating the tilting of blind slats;

FIG. 14 is a representative cord management system having the ability to selectively tilt the blind slats by using a braided or woven cord that converts from three strands in the head rail to a single strand that runs through the head rail to the operator; and

FIGS. 15A-17 illustrate various cord configurations in accordance with various representative embodiments of the present invention.

### DETAILED DESCRIPTION OF THE INVENTION

The following detailed description, in conjunction with the accompanying drawings (hereby expressly incorporated as part of this detailed description), sets forth specific numbers, materials, and configurations in order to provide a thorough understanding of the present invention. The following detailed description, in conjunction with the drawings, will enable one skilled in the relevant art to make and use the present invention.

A purpose of this detailed description being to describe the invention so as to enable one skilled in the art to make and use the present invention, the following description sets forth various specific examples, also referred to as “embodiments,” of the present invention. While the invention is described in conjunction with specific embodiments, it will be understood, because the embodiments are set forth for explanatory purposes only, that this description is not intended to limit the invention to these particular embodiments. Indeed, it is emphasized that the present invention can be embodied or performed in a variety of ways. The drawings and detailed description are merely representative of particular embodiments of the present invention.

As used herein, the term “cord drive component” is understood to include any device or combination of devices which are configured to facilitate movement of cords to rotate and/or lift a blind slat. For example, a cord drive component may include a pulley, a cam, a lever arm, a gear, a gear box, a bar, a friction device, a spring or cord lock and combinations thereof.

As used herein, the term “cord guide” is understood to include any device or combination of devices configured to prevent contact between a cord and the plate of a head rail. For example, a cord guide may include a grommet, an axle, a pulley, a post, an eyelet, a guide wheel, a protrusion, and combinations thereof. In some instances, a cord support may be placed directly in contact with an opening in the plate to serve as a barrier between a cord and the plate. A cord guide is further understood to include any structure or device capable of directing the pathway or movement of cords within the head rail.

As used herein, the term “head rail” is understood to include any device or structure that is part of a window covering, wherein the device or structure is configured to support lifting and/or tilting components, and blind slats of the window covering. A head rail may include any profile or design. For example, a head rail of the instant invention may comprise a low profile or may include a standard profile.

As used herein, the term “low profile” is understood to describe a dimensional height of a head rail that is less than a dimensional height of a standard profile head rail.

As used herein, the term “standard profile” is understood to describe a dimensional height of a head rail used in a traditional Venetian-type horizontal blind slat window covering.

One having skill in the art will appreciate that the embodiments shown and discussed herein comprise various components that may be scaled and adjusted as needed to accommodate blind slats of desired widths, lengths and thicknesses. For example, the embodiments shown and discussed herein may be scaled for use with a 0.5 inch blind slat, a 1.0 inch blind slat, a 1.5 inch blind slat, a 2.0 inch blind slat, a 2.5 inch blind slat, and/or a 3.0 inch blind slat. Alternatively, the embodiments shown and discussed herein may be scaled to any desired dimensions. Further, the embodiments shown and discussed herein may comprise any length sufficient to cover or partially cover a window opening, as may be desired. One having skill in the art will further appreciate that the embodiment shown and discussed herein may include any number of cord drive components, cord supports, belt drives, ladders, lift cords, and other components that may be desired or required to accommodate a blind slat having a desired shape, width and/or length.

Reference will now be made in detail to several embodiments of the invention. The various embodiments will be described in conjunction with the accompanying drawings wherein like elements are designated by like numeric characters throughout.

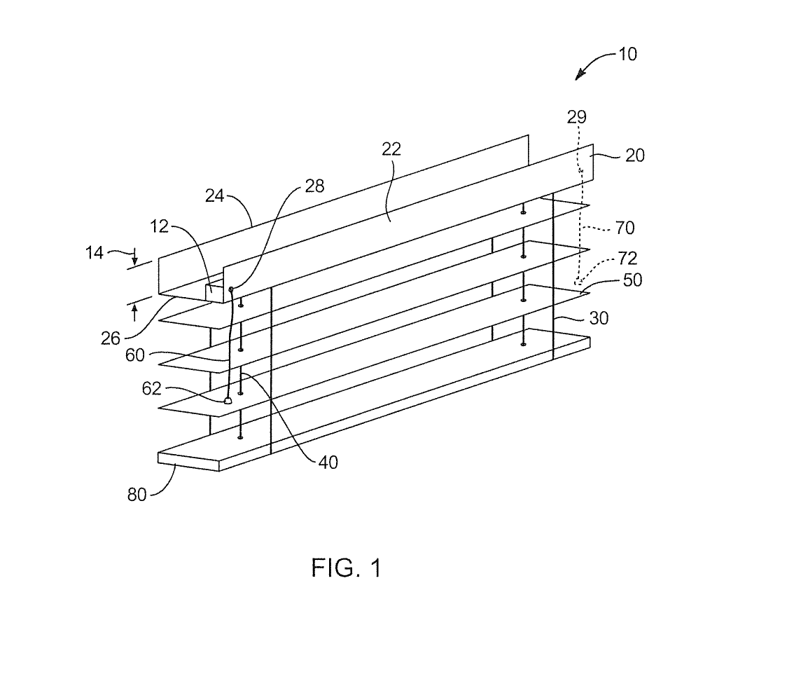

Referring now to FIG. 1, a representative window covering 10 is shown. Some embodiments of the present invention comprise a window covering 10 having a head rail 20 comprising a length sufficient for installation in a window opening (not shown). In some instances, head rail 20 comprises a U-shape channel, as shown. The proximal 22 and distal 24 sidewalls of the U-shape channel are generally provided to conceal various components and hardware of window covering 10. For example, sidewalls 22 and 24 may be provided to conceal gears, pulleys, cord locks, rods, cord guides, linkage, belts, cords and other components that make it possible to lift, lower, and tilt blind slats 50 and bottom rail 80, which are suspended beneath head rail 20 via a plurality of tilt 30 and lift 40 cords. Generally, these components are coupled to a plate 26 of head rail 20 and may comprise any configuration, orientation, and/or setup as may be desired to achieve the novel features of the instant invention. Tilt and/or lift cords 30 and 40 may also be coupled to a bottom rail 80 which may or may not be a blind slat, and further which may or may not define the lowest rung of the window covering.

In some instances, the components of head rail 20 are configured such that a single cord 60 exits head rail 20 via a single hole or opening 28. In some embodiments, single cord 60 passes through a cord lock 12 that is capable of selectively allowing and restricting movement of single cord 60 through opening 28. Single cord 60 comprises a single, terminal end 62 that is capable of being manipulated by a user to simultaneously move two or more cords 30 or 40 in unison. Thus, a user may lift, tilt, or lift and tilt blind slats 50 by manipulating a single cord 60.

In other instances, window covering 10 further comprises a second single cord 70 that exits a second single hole or opening 29 (shown in phantom). Second single cord 70 may also pass through a cord lock (not shown) that is capable of selectively allowing and restricting movement of single cord 70 through opening 29. Single cord 70 comprises a single, terminal end 72 that is capable of being manipulated a user to simultaneously move two or more cords 30 or 40 in unison. For example, in some embodiments single cord 60 is coupled to two or more of cords 30, and single cord 70 is coupled to two or more of cords 40. Thus, a user may manipulate single cord 60 to tilt blind slats 50, and also manipulate single cord 70 to lift and lower blind slats 50. Alternatively, window cover 10 may be configured such that single cord 60 is manipulated to lift and lower blind slats 50, and single cord 70 is manipulated to tilt blind slats 50.

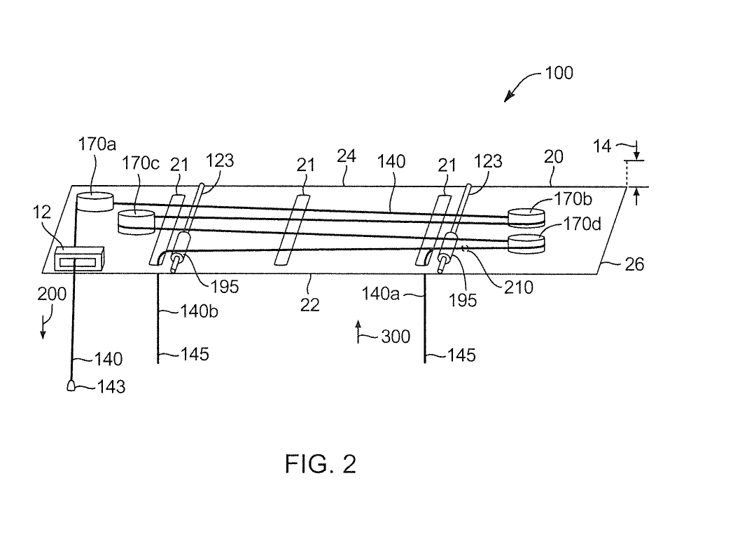

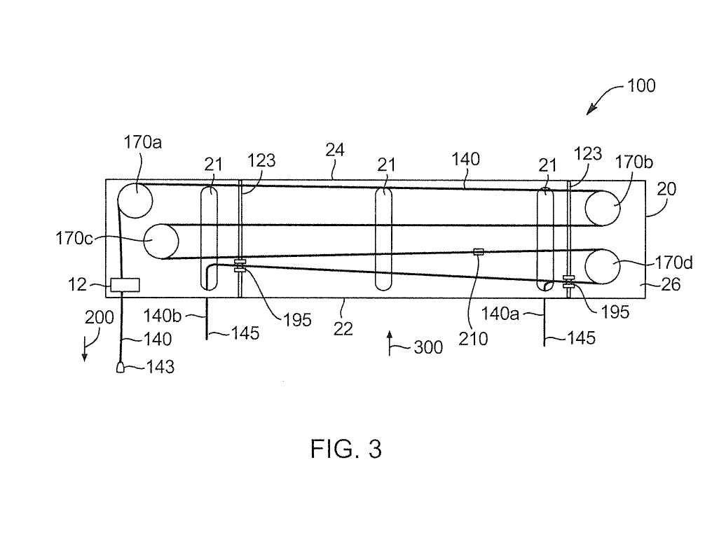

Referring now to FIGS. 2 and 3, a window cover 100 is shown. Some embodiments of the present invention comprise a lift cord 140 that is routed across head rail 20 in various configurations, as will be shown and discussed. For clarity in showing and describing lift cord 140, head rail 100 is shown without tilt cords and other components used therewith. However, one having skill in the art will appreciate that lift cord 140 and the other related components may be used in combination with the other components and features of the invention disclosed herein.

Lift cord 140 may comprise any type of cord or filament material known in the art. For example, lift cord 140 may comprise plastic, nylon, metal, natural fibers, and combinations thereof. Lift cord 140 comprises a terminal end 143 that is positioned external to plate 26 so as to be accessible to a user. Lift cord 140 further comprises one or more terminal ends 145 that exit plate 26 through one or more openings 21 and attach to bottom rail 80, as discussed above. When terminal end 143 is pulled in downward direction 200, terminal ends 145 are drawn towards plate 26 in upward direction 300, thereby lifting blind slats 50. Conversely, when terminal end 143 is moved towards plate 26 in upward direction 300, terminal ends 145 move away from plate 26 in downward direction 200, thereby lowering blind slats 50.

Plate 26 further comprises a cord lock device 12 that is configured to permit selective adjustment of lift cord 140. Cord lock device 12 may comprise any configuration and structure capable of permitting selective adjustment of lift cord 140. In some instances, cord lock device 12 comprises a safety lock feature whereby cord lock device 12 maintains a set position of lift cord 140 until the cord is pulled or otherwise manipulated by the user to release the lock.

Unlike traditional horizontal blinds, head rail 20 comprises a lift cord 140 having a single terminal end 403 that exits plate 26 via cord lock device 12, and further comprises a plurality of terminal ends 145 that exit plate 26 via openings 21. The singular terminal end 143 may reduce strangling hazards that are common with traditional lift cords having multiple first ends. The singular configuration of terminal end 143 further provides a clean appearance by preventing cord tangling and uneven cord lengths.

The lift cord system of head rail 20 further comprises a plurality of lift pulleys 170 rotatably coupled to plate 26 in a horizontal orientation. The plane of rotation for lift pulleys 170 is thus parallel to the surface of plate 26 on which the pulleys are rotatably coupled. In some instances, each lift pulley 170 comprises a center axis about which each pulley rotates. The center axis may comprise an axle that is coupled directly or indirectly to plate 26 and extends outwardly from the surface of plate 26 in a vector that is normal to a plane of plate 26.

In some instance, the horizontal orientation of lift pulleys 170 permits head rail 20 to have a low profile comprising an overall height 14 that is less than 0.5 inches. As such, head rail 20 may be installed without requiring a valance or other device configured to conceal head rail 20.

Lift pulleys 170 are configured to receive and manage the movement of lift cord 140 though head rail 20. In some instances, lift pulleys 170 are provided at opposite ends of plate 26 such that lift cord 140 is routed back and forth between the lift pulleys 170 across the length of plate 26. As thus configured, a substantial portion of lift cord 140 may be managed, consoled, and retained within head rail 20, while a single portion of lift cord 140 is positioned external to head rail 20. Further, the plurality and type of lift pulleys 170 may increases the mechanical advantage for head rail 20, thereby decreasing the force and effort needed to lift bottom rail 80 and blind slats 50 coupled thereto.

Head rail 20 may further comprise one or more guides 195 which are rotatably threaded onto an axle 123 and positioned in proximity to openings 21. Guides 195 are further configured to receive and support lift cord 140. In some instances, guides 195 are positioned in close proximity to openings 21 such that lift cord 140 passes over guides 195 and through openings 21 without contacting plate 26.

In some instances, guides 195 are capable of sliding along the length of axle 123 between the proximal and distal sides 22 and 24 of plate 26. Thus, as the blind slats 50 are rotated and thereby shifted proximally or distally under plate 26, guides 195 are configured to slide along axles 123 to reposition the location through which lift cord 140 exits plate 26 through openings 21.

Head rail 20 may comprise any number, size, shape, and combination of lift pulleys 170. Lift pulleys 170 may be arranged in any configuration to route lift cord 140 within head rail 20. For example, in some instances lift pulleys 170 are configured to route lift cords 140 the length of the head rail in a back and forth or zigzag configuration. Head rail 20 and lift pulleys 170 may further comprise cord tensioners, eyelets, and/or cord keepers to assist in retaining the position of lift cords 140 on lift pulleys 170.

In some embodiments, head rail 20 comprises a first lift pulley 170a that is positioned in close proximity to cord lock 12. First lift pulley 170a is directly linked to cord lock 12 via lift cord 140. Head rail 20 further comprises a second lift pulley 170b that is positioned on plate 26 at an end opposite first lift pulley 170a and cord lock 12. Thus, first lift pulley 170a is interposed between second lift pulley 170b and cord lock 12, and a middle of lift cord 140 is supported by first and second lift pulleys 170a and 170b.

In some instances, head rail 20 further comprises a third lift pulley 170c that is positioned on plate 26 in close proximity to first lift pulley 170a and cord lock 12. Thus, third lift pulley 170c is coupled to plate 26 at an end opposite second lift pulley 170b. First and second lift pulleys 170a and 170b are interposed between third lift pulley 170c and cord lock 12, such that lift cord 140 is routed from cord lock 12, over first and second lift pulleys 170a and 170b, and onto third lift pulley 170c.

In some instances, head rail 20 comprises a fourth lift pulley 170d that is positioned on plate 26 opposite first lift pulley 170a, third lift pulley 170c, and cord lock 12. As thus configured, lift cord 140 extends across the length of plate 26 from third lift pulley 170c to fourth lift pulley 170d. From the fourth lift pulley 170d, lift cord 140 travels back towards the opposite end of plate 26 and exits plate 26 at openings 21. In some instances, lift cord 140 passes over one or more guides 195 prior to exiting plate 26 through openings 21.

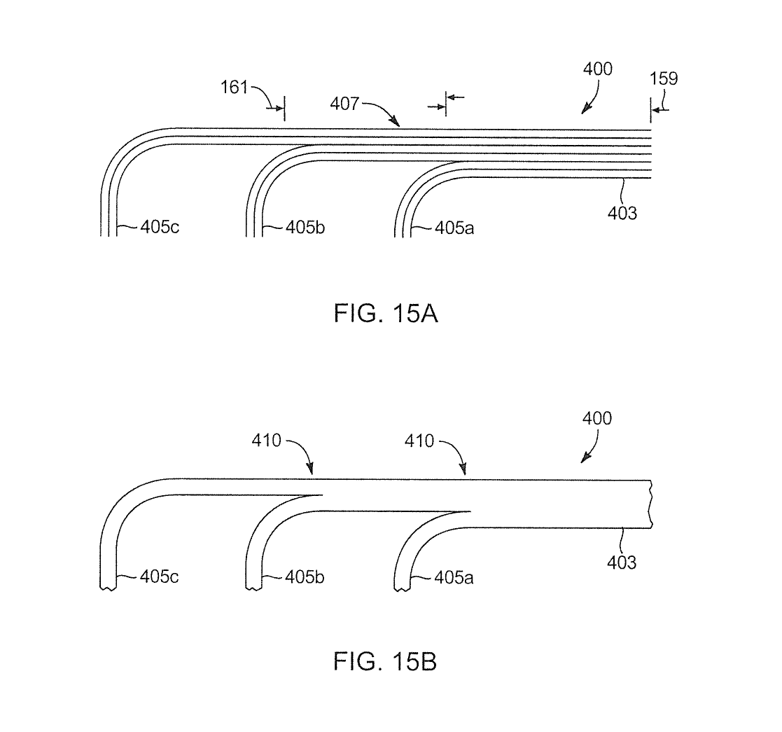

In some instances, lift cord 140 comprises a splice 210 where lift cord 140 is split to provide a plurality of terminal ends 140a and 140b. Splice 210 may comprise any structure, technique, device, or combinations thereof capable of providing a plurality of terminal ends. Specific examples of splice 210 are discussed below in connection with FIGS. 15A-17.

In general, splice 210 is configured to improve flexibility over existing types of rigid mechanical joints or devices. Splice 210 is also configured to provide increased strength over existing lift cord technologies. Further, splice 210 is configured to provide minimal dimension to lift cord 140, thereby eliminating interference or tangling with surrounding components. In some instances, splice 210 permits smooth movement of lift cord 140 over and around lift pulleys 170.

Splice 210 may be located on lift cord 140 at any position that prevents splice 210 from exiting openings 21 when bottom rail 80 is maximally lowered in downward direction 200. Further, splice 210 may be located on lift cord 140 at any position that prevents splice 210 from passing through cord lock 12 when bottom rail 80 is maximally lifted in upward direction 300. Thus, splice 210 is positioned on lift cord 140 so that splice 210 remains located within head rail 20 throughout the entire operation of window covering 100.

The number, size, shape, combination, and locations of lift pulleys may be adjusted as necessary or desired to implement the present teachings in a specific window covering. For example, in some instance a head rail may comprise more or less than four lift pulleys. In other instance, one or more lift pulleys may be configured to support the lift cord multiple times prior to exiting via openings 21. For example, the lift cord may contact a first lift pulley at a first position, then be supported by a second lift pulley, and then return to the first lift pulley to be supported at a second position on the first lift pulley. The head rail may further comprise more than one lift pulley rotatably coupled to plate 26 via a single axle.

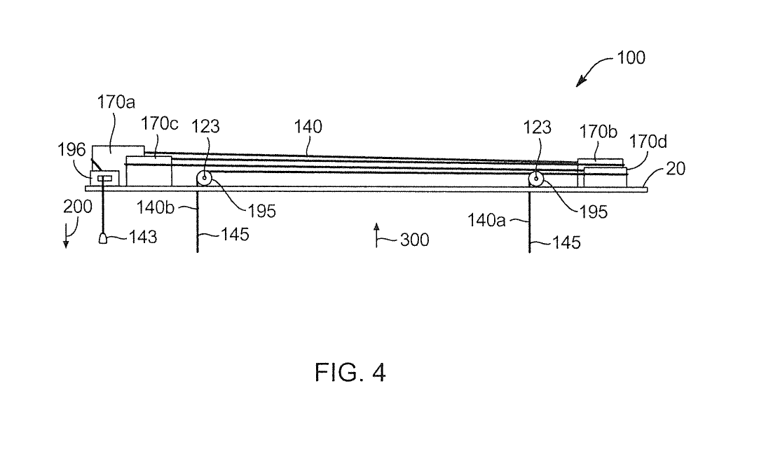

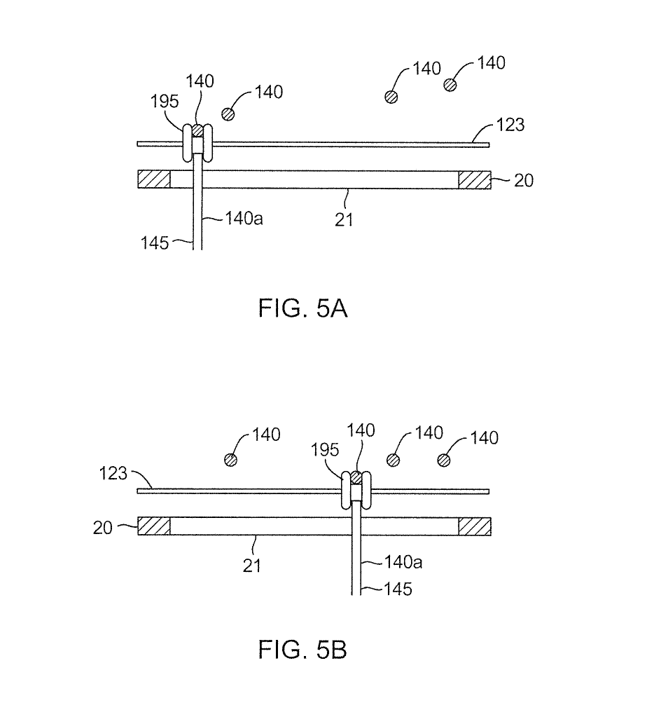

Referring now to FIGS. 4-5B, in some embodiments lift pulleys 170 are configured to position to prevent lift cord 140 from interfering with the remaining components of head rail 20. For example, in some instances lift pulleys 170 are positioned above the remaining components of head rail 20, such that lift cord 140 travels above the remaining components, as shown. As such, guides 195 are permitted to slide on axles 123 along the length of openings 21 without contacting lift cord 140. In other instances, lift pulleys 170 and lift cord 140 are located on plate 26 at a position opposite the window covering tilt cords and related components. Thus, the lift components and tilt components may be separately configured and operated without cross interference.

In some instances, first lift pulley 170a comprises a height or position that locates lift cord 140 above second lift pulley 170b, as shown in FIGS. 4 and 5A. Thus, lift cord 140 slopes slightly downward from first lift pulley 170a to second lift pulley 170b. Similarly, second lift pulley 170b comprises a height or position that locates lift cord 140 above third lift pulley 170c. Again, lift cord 140 slopes slightly downward from second lift pulley 170b to third lift pulley 170c. Further, third lift pulley comprises a height or position that locates lift cord 140 above fourth lift pulley 170d. As such, lift cord 140 slopes slightly downward from third lift pulley 170c to fourth lift pulley 170d. In some instances, fourth lift pulley comprises a height or position that locates lift cord 140 at approximately the same height as guide 195. Thus, guide 195 may slide or travel along axle 123 without contacting lift cord 140.

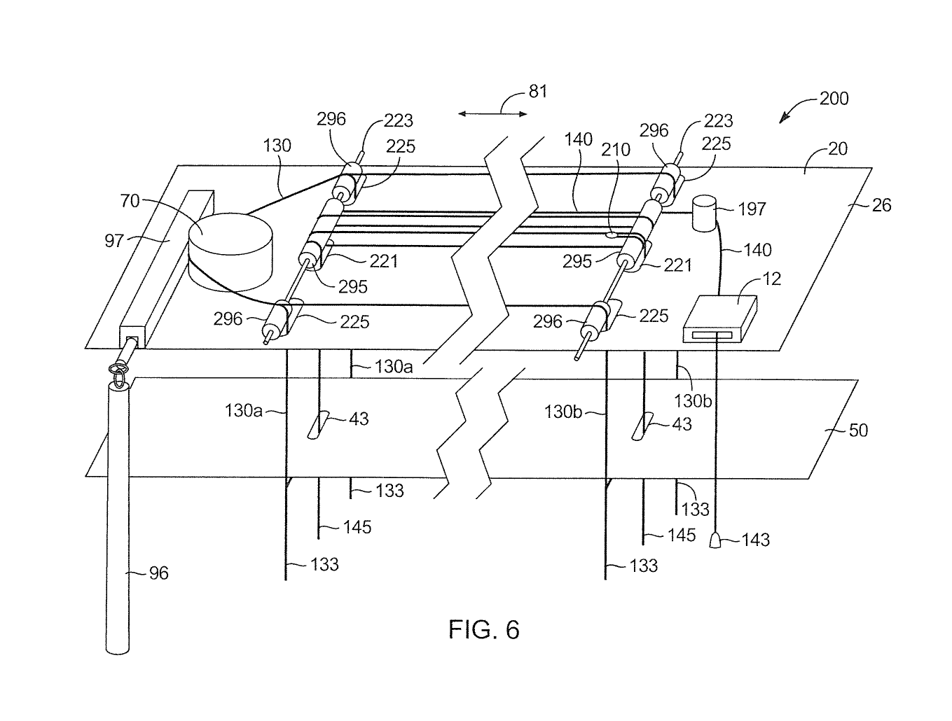

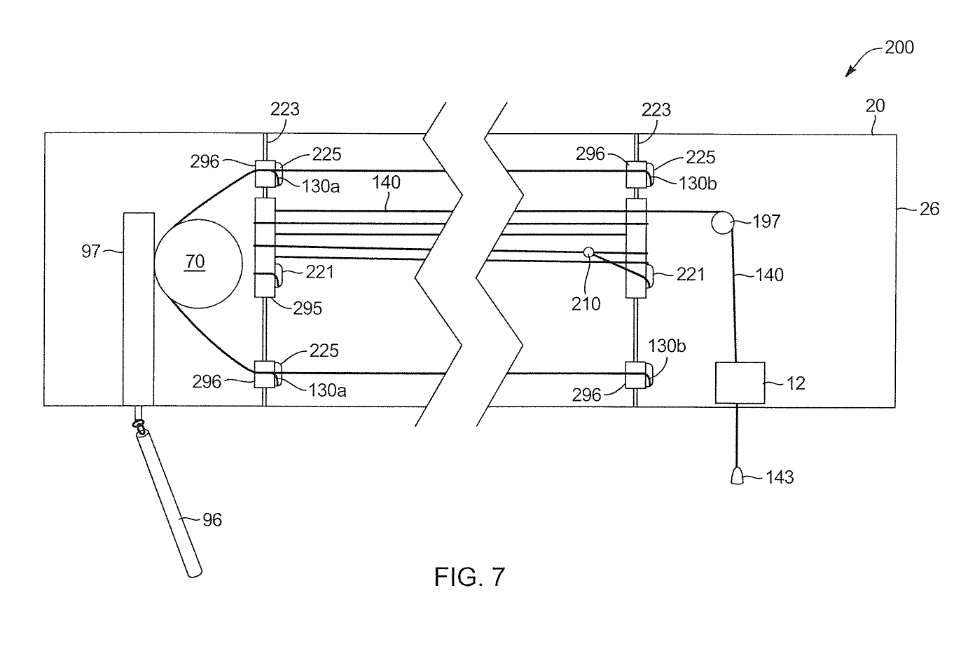

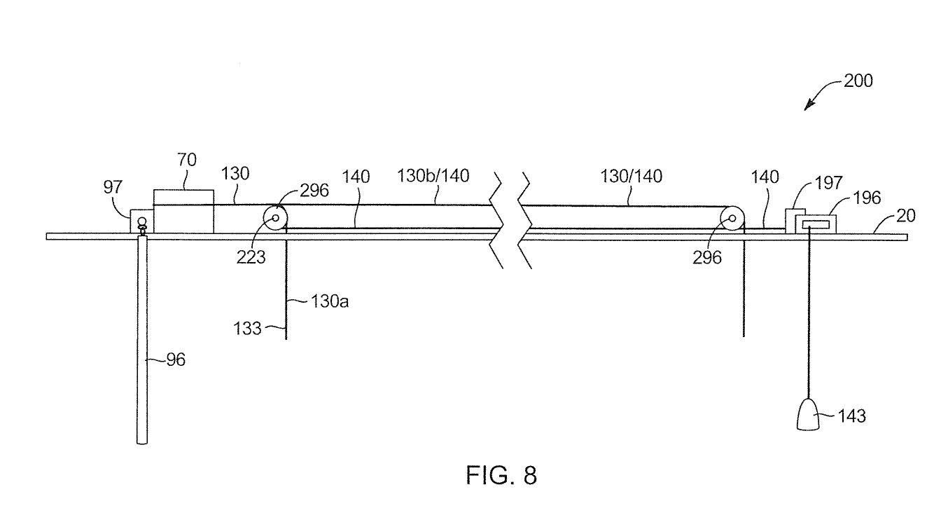

FIGS. 6-10 demonstrate a window covering 200 having a head rail 20 and plate 26 on which is simultaneously configured a lift cord 140 and a tilt cord 130. With reference to FIGS. 6-8, in some instances lift cord 140 comprises a terminal end 143 that is positioned external to head rail 20, and further comprises a plurality of second ends 145 that pass through blind slats 50 and are secured to bottom rail 80. A middle portion or length of lift cord 140 passes through cord lock device 12 and around a guide 197. The remaining length of lift cord 140 passes between oppositely positioned cord guides 295 in a zigzag pattern, as shown. In some embodiments, lift cord 140 extends between the cord guides 295 two times. In other embodiments, lift cord 140 extends between the cord guides more than two times.

With continued reference to FIGS. 6-10, in some embodiments cord guides 295 are centrally located on axles 223 such that tilt cord 140 may exit through openings 221 in plate 26. Openings 221 are generally centrally located in plate 26 and in proximal alignment with a central hole or slot 43 in blind slats 50. In some instances, the position of cord guides 295 is maintained by a plastic housing, retention washer, or snap ring that is secured to axles 223. In other instances, cord guides 295 are affixed to axles 223 via an adhesive or epoxy.

Lift cord 140 may comprise a splice 210 whereby the single filament of lift cord 140 is split or extended to provide a second lift cord along the length of blind slat 50. In this way, a single lift cord 140 may be modified to include a plurality of terminal ends 145, as discussed and shown previously.

In some instances, tilt cord 130 is coupled to a cord drive component 70 that is rotatably driven by a rotating device 96 that is operable connected to a worm gear 97. As cord drive component 70 is rotated, tilt cord 130 is moved in forward and rearward directions 81 thereby extending and retracting the working ends 133 of tilt cord 130 to tilt blind slat 50. In some embodiments, tilt cord 130 passes over additional cord guides 296 to prevent contact between tilt cord 130 and openings 225 as tilt cord 130 passes therethrough. In some instances, cord guides 296 are positioned towards the proximal and distal edges of plate 26 so that tilt cord 130 is approximately in alignment with the proximal and distal edges of blind slat 50 when tilt cord 130 passes through openings 225.

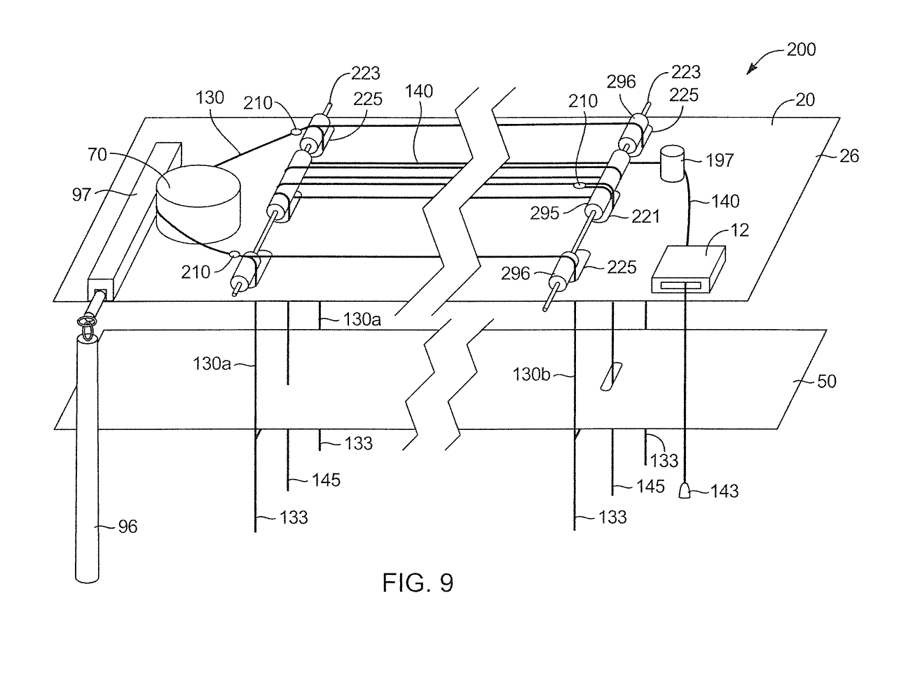

Tilt cord 130 may comprise a woven or braided configuration such that the portion of tilt cord 130 that interfaces with cord drive component 70 is a single filament, or comprises a single cord woven from a plurality of individual cords or individual filaments. This single filament is split or divided to provide a first lift cord 130a and a second lift cord 130b, as shown. First and second lift cords 130a and 130b are configured to contact blind slat 50 at various positions along the length thereof to provide uniform tilting. Alternatively, tilt cord 130 may comprise one or more splices 210, whereby the single tilt cord 130 may be modified to include a plurality of terminal ends, as shown in FIG. 9.

In general, splice 210 may comprise any structure, device or combination thereof capable of producing a cord having a single terminal end and a plurality of working ends. For example, in some instances splice 210 comprises a woven joint. In other instances, splice 210 comprises a braided joint. Further still, in some instances splice 210 comprises a mechanical connection, such as a clamp, a glue joint, a weld, or a knot.

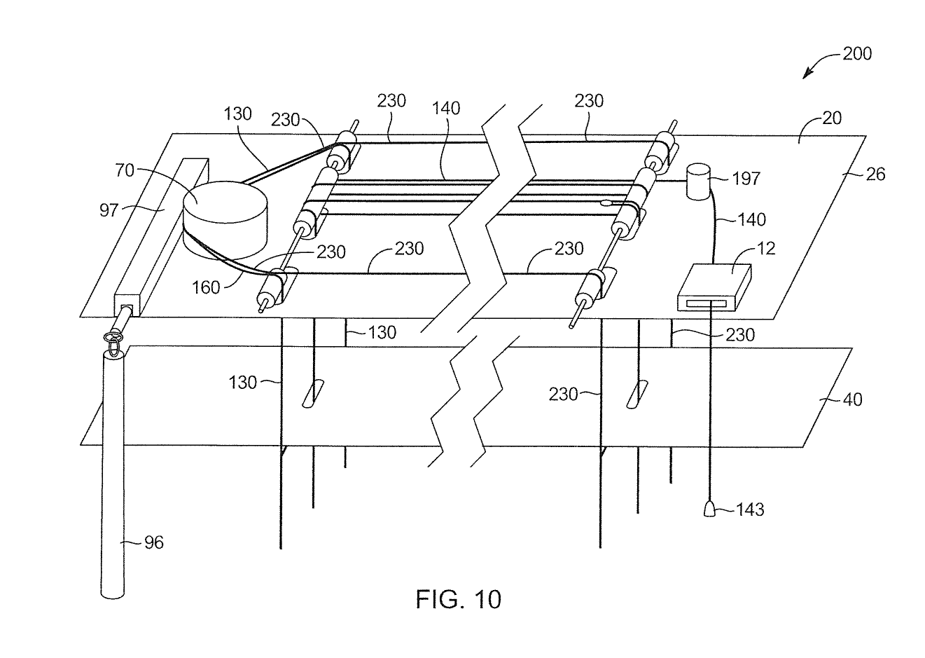

Further still, in some instances tilt cord 130 comprises a plurality of tilt cords 130 and 230, as shown in FIG. 10. Tilt cords 130 and 230 are independently coupled to cord drive component 70 and configured to move in unison as cord drive component is rotated. In some instances, cord drive component 70 comprises a first groove configured to receive tilt cord 130, and further comprises a second groove configured to receive tilt cord 230. In other instances, cord drive component 70 comprises a single groove configured to receive both tilt cords 130 and 230. Further, in some instances tilt cords 130 and 230 are coupled together via a mechanical clamp, crimp, knot, and/or an adhesive, thereby coordinating the movements of the cords.

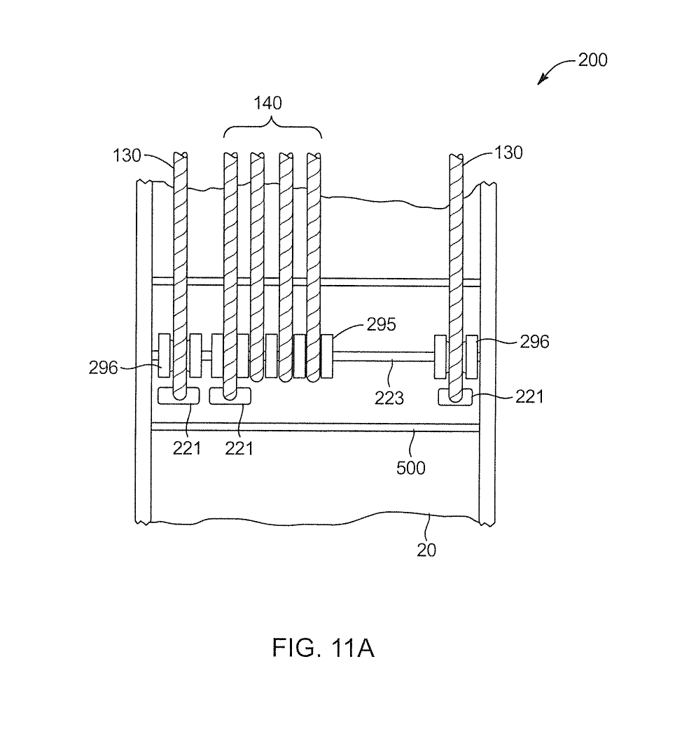

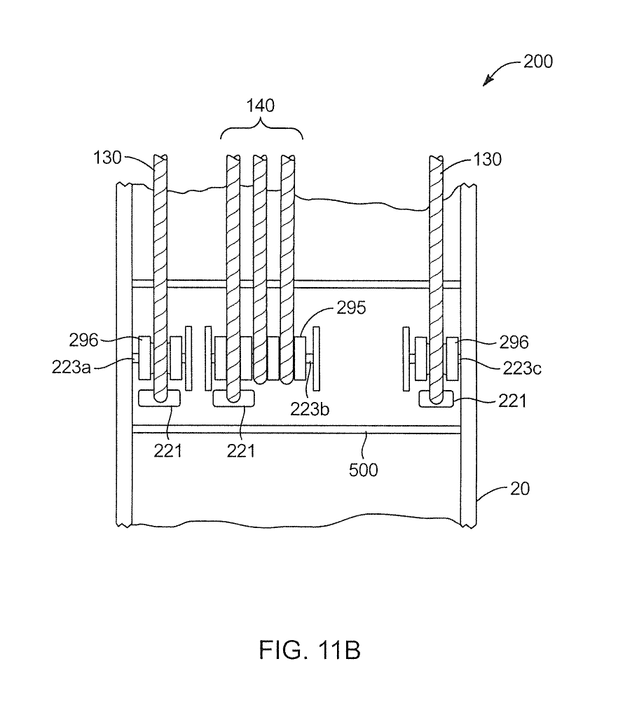

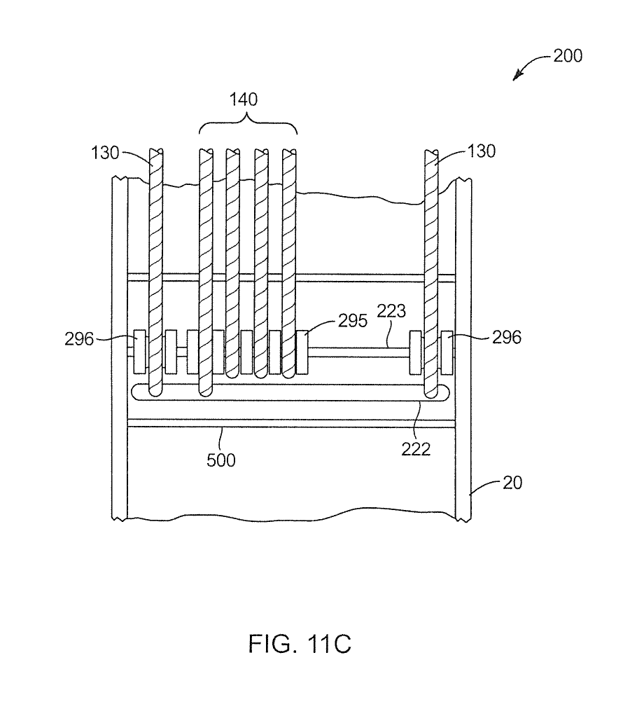

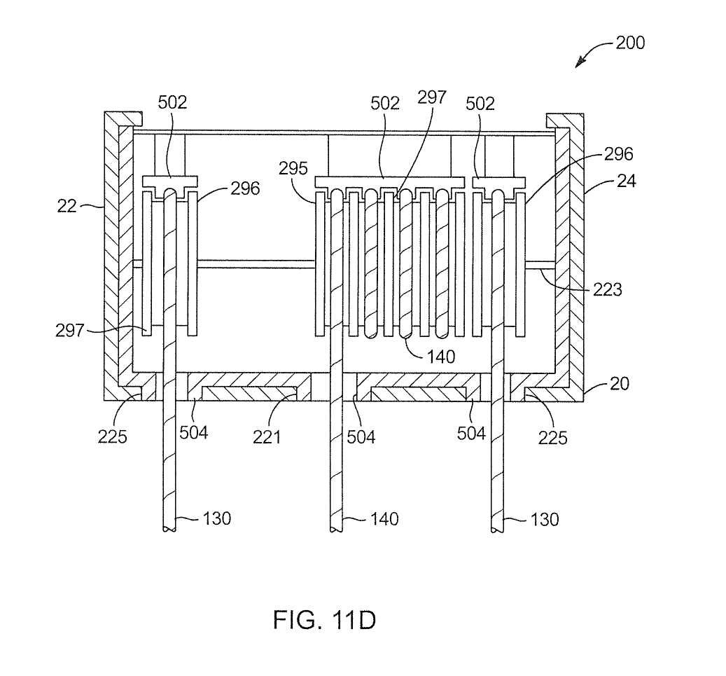

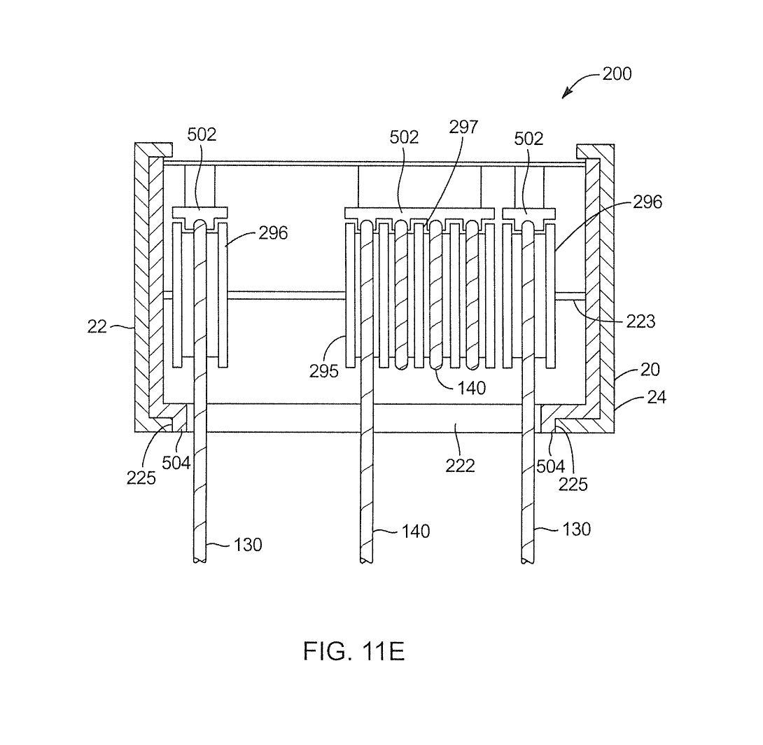

Referring now to FIG. 11A, a top view of window covering 200 is shown. In some embodiments cord guides 295 comprise a plurality of grooves 297 configured to receive and retain the positions of lift cord 140 along the length of each cord guide 295. Thus, cord guides 295 may rotate about and slide on axles 223 while maintaining a desired spacing between the portions or sections of lift cord 140 supported thereon. Axles 223 may further be configured to support additional cord guides 296 that may also be of vary in size and slide on the axel to support tilt cords 130 within a single groove. In some embodiments, cord guides 295 and 296 have separate and independent axels on which they are supported, as shown in FIG. 11B. In other embodiments, cord guides 295 and 296 may vary in size, shape, and location within the housing 500 (not shown). With continued reference to FIGS. 11A and 11B, in some embodiments cord guides 295 and 296 further comprise a housing 500 that is sized and configured to couple to head rail 20. Housing 500 may comprise any material or combination of materials compatible for use in a window covering. In some instances, housing 500 comprises a polymer material, such as nylon, polypropylene or polyethylene. In other instances, housing 500 comprises a metallic material. Housing 500 may be attached to plate 26 of head rail 20 by any compatible means or method. In some instances, housing 500 is secured to plate 20 via an adhesive. In other instances, housing 500 is secured to plate 20 via a mechanical fastener. In some embodiments, independent axels 223a-223c and cord guides 295 or 296 may be positioned in any configuration necessary to accomplish tilting and lifting the blind slats. For example, window housing 500 may comprise two independent axles, wherein cord guides 295 and 296 occupy a single axle, and cord guide 296 is coupled to an independent axle, and any combination thereof suitable for the purposes of manipulating the blind slats. In some instances, the positions of axles 223a-223c may be independently determined, set and/or adjusted as needed to accommodate various sizes, numbers and dimensions of cord guides 295 and/or 296. Accordingly, cord guides 295 and 296 may vary in number and dimensions as desired to accommodate cords 130 and 140. Furthermore, the positions of axles 223a-223c and their respective cord guides may be positioned on opposite sides of opening 221 in any combination, as may be desired. Housing 500 may further be modified to exclude one or more axles and cord guides as may be desired to limit the function of the window covering. For example, in some instances a housing is provided that includes only components for tilting the blind slats. Alternatively, in some instances a housing is provided that includes only components for lifting the blind slats.

In some instances, housing 500 comprises one or more elongated openings 222, as shown in FIG. 11C. As thus configured, cord guides 295 and 296 may slide the length of axel 223 to reposition their respective cords 140 and 130 within the elongated opening 222. Axle 223 may further comprise one or more stops (not shown) to limit or prevent the lateral movement of one or more cord guides.

Referring now to FIG. 11D, in some instances housing 500 is configured to snap fit within head rail 20, as shown. Housing 500 may further comprise a plurality of openings or protrusions 504 that extend through openings 221 of plate 26 and provide a barrier between cords 140 and 130 and openings 221. In some instances, opening 221 comprises an elongated opening, as shown in FIG. 11E. Housing 500 may further comprise one or more protrusions 504 which are provided to prevent the tilt and lift cords from contacting the head rail as the cords pass through their respective openings 221 and 225.

Housing 500 may further comprise one or more cord retention devices 502 that interface with grooves 297 to retain the positions of lift cord 140 and tilt cord 130 within their respective grooves. In some instances, cord retention devices 502 are spring loaded to maintain a desired pressure on cords 130 and/or 140. In other instances, cord retention devices 502 are held within their respective grooves by gravity. Further still, in some instances a distance between cord retention devices 502 and their respective grooves 297 is fixed by a rigid connection between cord retention devices 502 and either housing 500 or head rail 20.

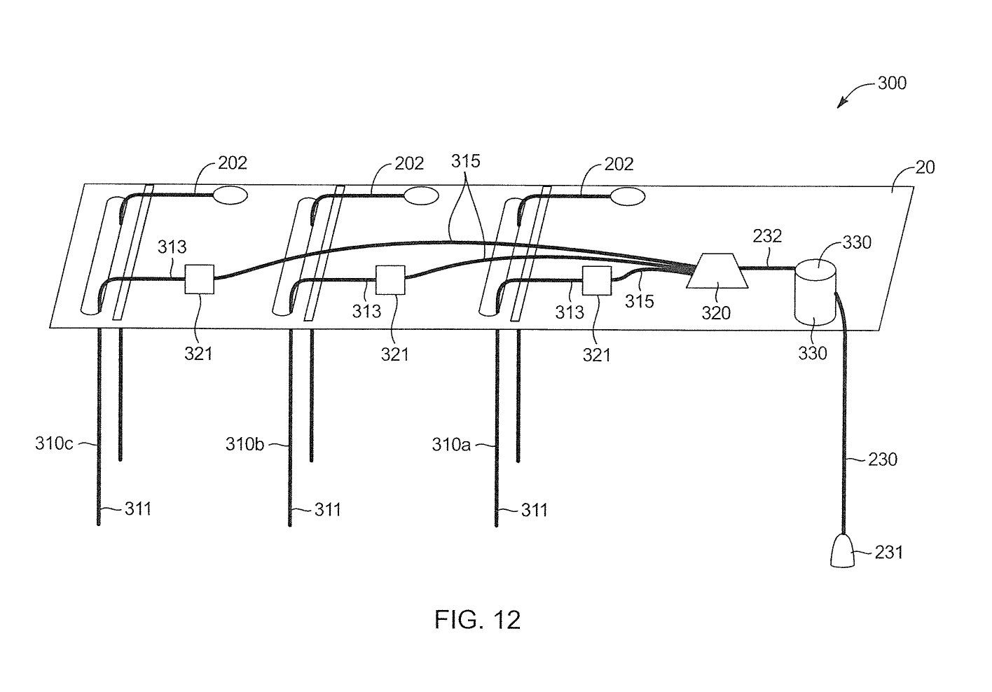

Referring now to FIG. 12, a representative cord management system having the ability to tilt blind slats by using connectors, strings, and a friction device is shown. In summary, the device shown in FIG. 12 provides a window covering having a head rail comprising a plate which includes a top surface, a bottom surface, a front edge, and a rear edge. In some embodiments, the head rail comprises a u-channel in which the various components of the window covering are concealed.

Various embodiments of the present invention achieve cord management within a head rail by providing and utilizing various cords having a single terminal or user accessible end that is coupled to a plurality of working ends. As such, the user may manipulate the single terminal end to actuate the plurality of working ends in unison.

For example, the cord management system of FIG. 12 includes a first set of cords 202 having an end that is fixedly attached to the head rail 20. Cords 202 comprise a fixed length configured to maintain a desired and fixed distance between plate 20 and each blind slat suspended thereunder. A tilt cord 230 is further provided having a first or terminal end 231 and a second end 232 that is coupled to a primary connector 320. A middle portion of tilt cord 230 is in contact with a friction device 330 which is configured to permit selective adjustment of terminal end 231 with respect to plate 20. In some instances, friction device 330 comprises a cord lock.

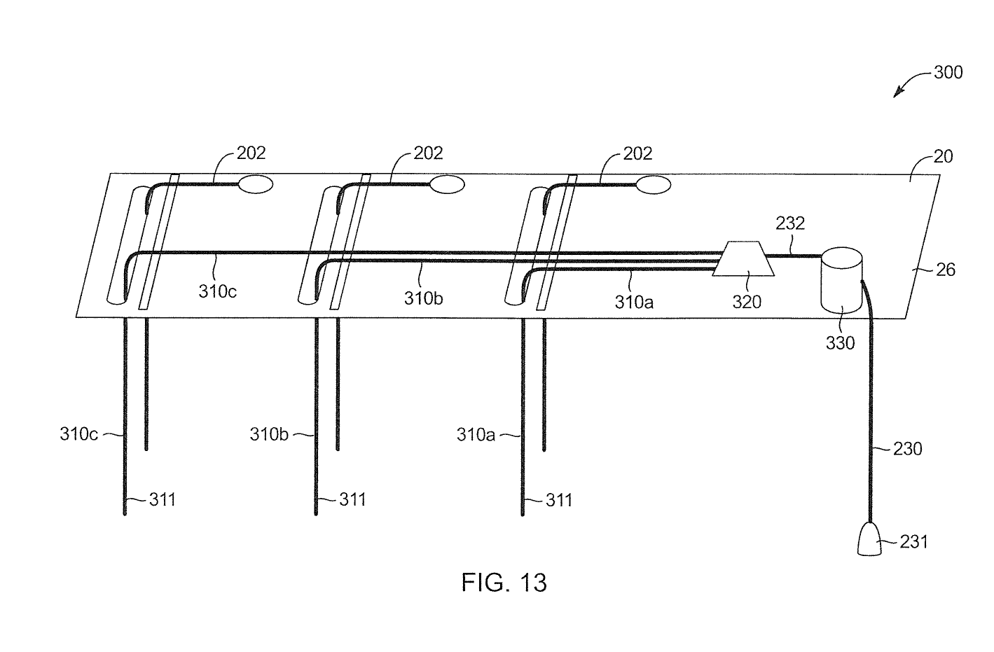

Window covering 300 further comprises a plurality of secondary tilt cords 310a-c. Each of the secondary tilt cords 310 comprise a first or working end 311 that is coupled to each of the blind slats suspended beneath plate 20. The secondary tilt cords 310 further comprise a second end 313 that is connected to a secondary connector 321. Secondary connectors 321 are further connected to primary connector 320 via individual jumper cords 315. In some instances, second end 313 is directly coupled to primary connector 320 without requiring secondary connectors 321 and jumper cords 315, as shown in FIG. 13.

With continued reference to FIG. 12, primary connector 320, jumper cords 315, and secondary connectors 321 permit synchronized movement secondary tilt cords 310a-c when primary tilt cord 230 is adjusted. In some embodiments, a distance between working ends 311 and plate 20 is decreased as a distance between terminal end 231 of primary tilt cord 230 and plate 20 is increased, such as when the blind slats are in an opened position. This is accomplished as terminal end 231 is pulled downwardly, away from plate 20. Conversely, a distance between working ends 311 and plate 20 is increased as a distance between terminal end 231 of primary tilt cord 230 and plate 20 is decreased, such as when the blind slats are in a closed position.

Thus, at least some embodiments embrace cord management, connection, and/or interaction to accomplish the selective tilting of the blind slats. In some embodiments, strings, connectors, and friction devices are used. Strings of any type sufficient to accomplish the purpose may be used. For example strings having a metallic material, composite material, natural fiber material, or a combination thereof may be used. The connectors used to combine or consolidate cords comprise any material suitable for its purpose, including a polymer, metal, or other material. Other methods of combining multiple cords may include heat, IR, sonic welding, fuse, and any other method suitable for use in window coverings. Friction devices comprise any device suitable to retain the cord in a position and allow for adjustability. Examples include a cord lock, cord cleat, set of friction posts, pulleys, cogs, worm gears, etc.

Further embodiments include a second set of cords, connectors, and/or friction device(s) to manipulate a second set of tilt cords. The second set of tilt cords functions in the same manner as the first set. Further, a single friction device may be used to manipulate both the first and second sets of tilt cords. Lift cords and components related to lifting and lowering the blind slats may also be included in addition to the tilt cords and tilting functions of the window covering.

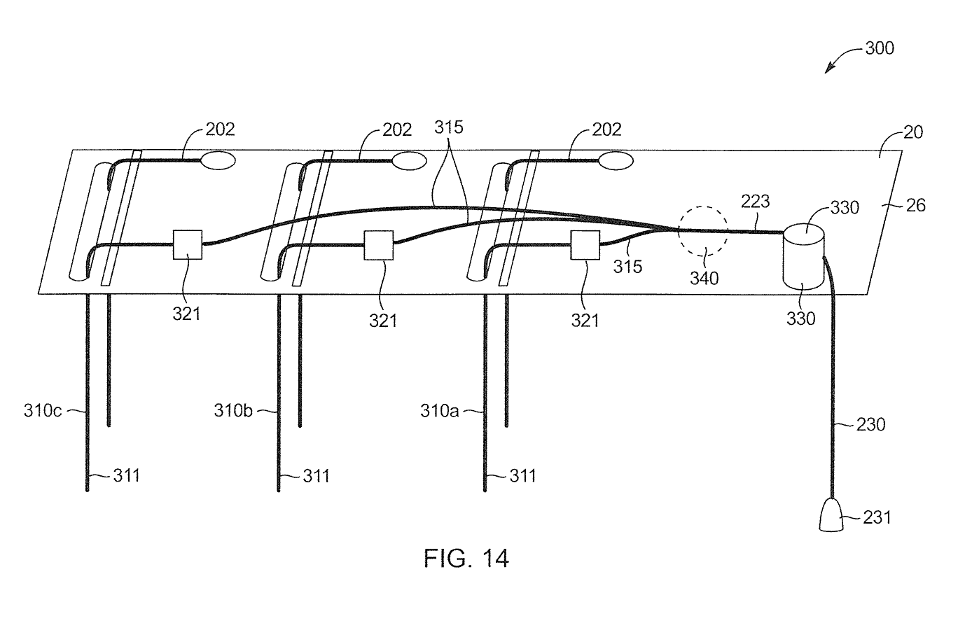

FIG. 14 is a representative cord management system having the ability to selectively tilt the blind slats by using a braided cord at position 340 that converts from three strands in the head rail to a single strand having a terminal end 231 that runs through the head rail to the operator. Thus, window covering 300 consolidates jumper cords 315 and connects them to lift cord 230 without requiring a primary connector. Friction device 330 maintains the desired position of the blind slats, i.e.: open, closed, or somewhere in-between. Examples include a cord lock, tensioned pulley, set of bars, etc. Position 340 comprises a joint in the braided or woven cord at which the individual jumper cords 315 become a single lift cord 230. Tilt cord 230 comprises a single cord that is woven in such a way that it becomes three separate cords at a specific joint or at multiple joints depending on the number of tilt cords. The separation can happen at one or many locations. In the illustrated embodiment, only a single tilt cord 230 is used by the operator to open and close the blind(s).

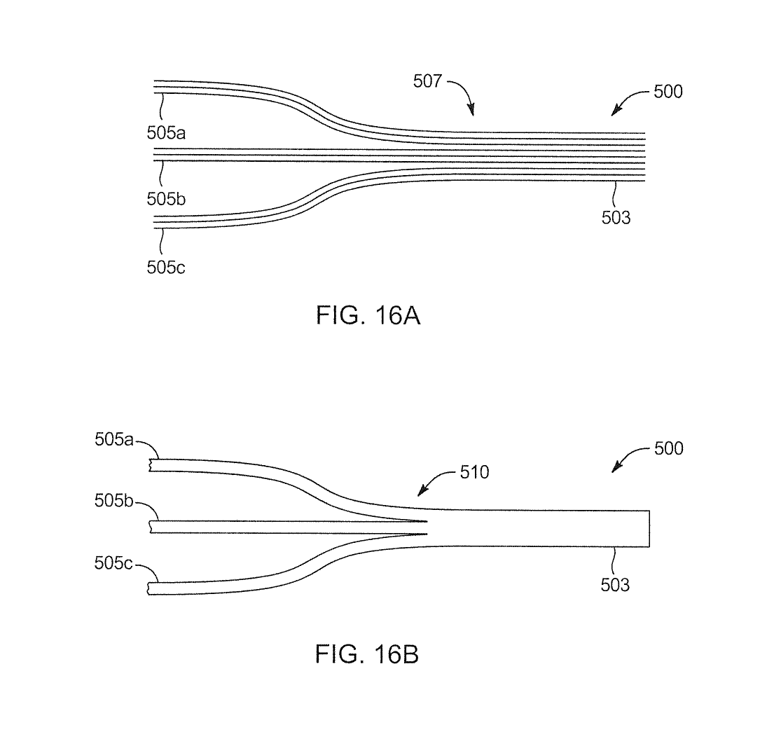

Referring now to FIGS. 15A-16B, the present invention further includes a cord 400 having a first end 403 and a plurality of working ends 405. Cord 400 may be used in any capacity where a cord is desired having a single terminal end and a plurality of working ends, as described herein. Some embodiments of the present invention provide a woven cord that comprises a splice 410 to transition from a single terminal end 403 to multiple working ends 405. In some instances, lift cord is woven from a plurality of threads, cords, and/or filaments 407 using known rope weaving, lashing and/or braiding techniques. At a desired distance 159 from terminal end 403, a portion of the threads 407 is separated from the remaining threads and manipulated to provide a separate cord having a separate working end 405a. By this process, a seamless splice 410 is provided. The remaining strands are further woven, braided or lashed in a continuous manner until a second desired distance 161 is achieved. At this point, a second portion of threads is separated from the plurality of threads 407 and further manipulated to provide a separate cord having a separate working end 405b. The remaining strands are further woven, braided or lashed in a continuous manner to provide a third, separate cord having a separate working end 405c.

This process may be repeated as many times as may be desired to provide a desired number of cords having separate working ends. The user must simply calculate the number of threads, cords, and/or filaments needed to produce the final number of individual cords. The user must also calculate the initial length of the plurality of threads 407 to ensure sufficient material to provide a cord 400 having the desired final length.

In some instances, a cord 400 is provided having a single backbone from which each of the individual cords are branched out of along the length of the cord, as shown in FIGS. 15A and 15B. In configuration 15B, the diameter of the backbone decreases along the length of the cord due to the removal of strands from the backbone at each of the plurality of splices 410.

In other instances, a lift cord 500 is provided having a single backbone with a single end from which each of the individual cords 505a-c extend, as shown in FIGS. 16A and 16B. In this configuration, the diameter of the backbone is constant. The individual cords 505a-c are provided by dividing the strands 507 of the backbone into individual groups that are then independently woven or otherwise manipulated together, thereby providing a single, shared splice 510.

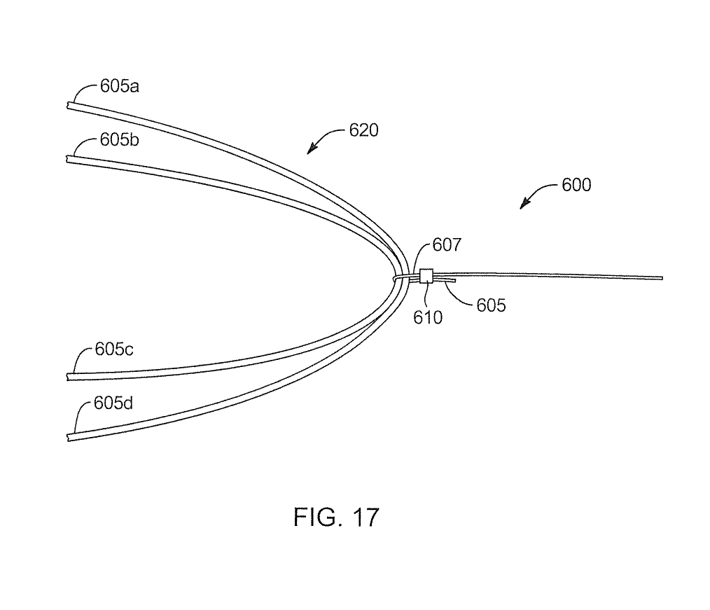

With reference to FIG. 17, in some instances cord 600 comprises an end 605 that forms a loop 607. Loop 607 may be formed by any compatible method, device, or process. For example, in some embodiments loop 607 is formed by tying a knot in end 605. In other instances, loop 607 is provided by lashing end 605. Further, in some instances loop 607 is provided by bonding end 605 via hot melt, plastic welding, welding, and/or fusing. Loop 607 may also be provided by gluing or epoxying end 605. Further still, in some instances loop 607 is provided with a mechanical fastener 610, such as a clamp.

A plurality of working ends 605a-605d may be added to a single cord for use in tilt or lift by threading a plurality of individual cords 620 through loop 607. In some instances, the individual cords are permitted to slide or reposition within loop 607. In other instances, individual cords 620 are fixed within loop 607, such as by tying a knot, lashing, glue, welding, fusing, clamping, etc.

It is underscored that the present invention may be embodied in other specific forms without departing from its spirit or essential characteristics. For example, in some instances a head rail may be provided which substitutes circular posts for the various disclosed pulleys. Further, the separate axles may be substituted for the various cord guides.

Further, the various components and teachings of the present invention may further be used with other types of window coverings, such as cellular blinds, roman blinds, draperies, and any other window covering application where multiple locations are controlled by a single operating location.

Further still, the methods, techniques, and components disclosed herein may be used in lifting and tilting a blind in a single device, whereby the device comprises one or more of the cords disclosed herein. Therefore, the described embodiments herein should be deemed only as illustrative.

What is claimed is:

1. A cord management system for a window covering, the system comprising:
a head rail comprising a plate;
a cord guide rotatably coupled to the plate via an axle and in proximity to an opening in the plate; and
a first cord having a working end coupled to a bottom rail of a set of slats, and further having a terminal end positioned external to the plate and accessible to a user, the first cord having a middle section supported by the cord guide and passing through the opening, the first cord being horizontally oriented along a length of the plate, wherein a distance between the terminal end of the first cord and the plate decreases as a distance between the working end of the first cord and the plate increases.

2. The system of claim 1, wherein the head rail comprises a height that is less than or equal to 0.5 inches.

3. The system of claim 1, further comprising:
a cord drive component rotatably coupled to the plate in a generally horizontal orientation; and
a tilt cord having a first terminal end, a second terminal end, a first working end, and a second working end, the first working end being coupled to a proximal edge of the blind slat, the second working end being couple to a distal edge of the blind slat, and the first and second terminal ends being coupled to the cord drive component, wherein when the cord drive component is rotated, a distance between the first working end and the plate decreases as a distance between the second working end and the plate increases thereby rotating an axial position of the blind slat.

4. The system of claim 3, further comprising a first tilt cord guide and a second tilt cord guide in proximity to a second opening and a third opening in the plate, and configured to support a portion of the tilt cord that passes through the second and third openings.

5. The system of claim 4, wherein the second and third openings are position proximate to a distal edge and a proximal edge of the plate and in proximate alignment with the distal and proximal edges of the blind slat.

6. The system of claim 1, further comprising:
a second cord guide rotatably coupled to the plate via a second axle and in proximity to a second opening in the plate, wherein the cord is routed between the first and second cord guides in a zigzag pattern; and
a second cord having a second working end coupled to the bottom rail of the set of slats, the second cord having a middle length supported by the second cord guide, the second cord further having a terminal end that is coupled to the middle section of the first cord, the second cord being horizontally oriented along the length of the plate, wherein a distance between the second working end of the second cord and the plate decreases as the distance between the terminal end of the first cord and the plate increases.

7. The system of claim 6, wherein the second cord is coupled to the middle section of the first cord via a splice.

8. A cord management device comprising a housing having an outer surface capable of being fixedly secured to a head rail, the housing further having an inner surface capable of supporting an axle on which is rotatably supported one or more cord guides, the housing further comprising one or more protrusions configured to be placed within one or more openings in the head rail and having a pathway therethrough which a cord travels such that the protrusion prevents the cord from contacting the head rail.

9. The device of claim 8, further comprising one or more cord retention devices supported by the housing, a portion of the one or more cord retention devices interfacing with a groove of the one or more cord guides to retain a position of the cord within the groove.

10. The device of claim 9, wherein the one or more cord guides comprises a plurality of grooves.

11. The device of claim 9, wherein the one or more cord retention devices are spring loaded.

12. The device of claim 8, wherein the housing is snap fitted into the head rail.

13. The device of claim 8, wherein a position of the one or more cord guides on the axle is maintained by at least one of a portion of the housing, a retention washer, a snap ring, an adhesive, and an epoxy.

14. The device of claim 8, wherein the axle comprises a plurality of axles located at a plurality of locations on the inner surface.

15. A cord device for a window covering, the cord device comprising;
a single terminal end that is positioned external to a head rail of a window covering such that the single terminal end is accessible to a user;
a plurality of working ends; and
a splice interposed between the single terminal end and the plurality of working ends.

16. The device of claim 15, wherein the cord comprises a single filament.

17. The device of claim 15, wherein the cord is provided from a plurality of single filaments by braiding, weaving or lashing the plurality of single filaments.

18. The device of claim 15, wherein the cord comprises a plurality of splices.

19. The device of claim 18, wherein the cord comprises a single backbone and the plurality of splices are spaced along the single backbone to provide the plurality of working ends.
